(19) United States
(12) Patent Application Publication
(10) Pub. No.: US 2025/0253439 A1
(43) Pub. Date: Aug. 7, 2025

(54) TEMPERATURE CONTROL AGENT FOR TEMPERATURE CONTROL OF A COMPONENT, ESPECIALLY A BATTERY ELECTRIC VEHICLE

(71) Applicant: MAHLE International GmbH, Stuttgart (DE)

(72) Inventor: Ralf Zink, Stuttgart (DE)

(21) Appl. No.: 19/043,456

(22) Filed: Feb. 1, 2025

(30) Foreign Application Priority Data
Feb. 1, 2024 (DE) 102024102849.1

(51) Int. Cl. H01M 10/6568; H01M 8/04029; H01M 10/613; H01M 10/625

(52) U.S. Cl. CPC H01M 10/6568; H01M 8/04029; H01M 10/613; H01M 10/625

(57) ABSTRACT

A temperature control arrangement for controlling the temperature of at least one component may include a temperature control circuit, a conveyor configured to drive a temperature control agent in the temperature control circuit, and a storage tank for intermediate storage of the temperature control agent. The storage tank may include a housing surrounding a housing interior, a fluid inlet arranged on the housing, a fluid outlet arranged on the housing, and at least one molded body composed of an open-pored foam and through which the temperature control agent is flowable. The fluid inlet may have an inlet opening via which the temperature control agent is introducible into the housing interior. The fluid outlet may have an outlet opening via which the temperature control agent is dischargeable after passing through the housing interior. The at least one molded body may be arranged in the housing interior.

### CROSS-REFERENCE TO RELATED APPLICATION

This application claims priority to German Patent Application No. DE 102024102849.1, filed on Feb. 1, 2024, the contents of which is hereby incorporated by reference in its entirety.

### TECHNICAL FIELD

The present invention relates to a temperature control arrangement for controlling the temperature of a component, in particular of a battery-powered electric vehicle.

BACKGROUND

A component of a battery-powered electric vehicle that generates waste heat during operation, for example a battery for driving the vehicle, can be arranged in a temperature control circuit and immersed-cooled with a temperature control agent circulating in the temperature control circuit, such as oil. This means that the temperature control agent flows directly around the component whose temperature is to be controlled. A storage tank of this kind can store temperature control agent to compensate for temperature-related volume expansion in the temperature control circuit. Similarly, a storage tank that is not completely filled with the temperature control agent can act as an equalizing volume when the volume of the temperature control agent expands throughout the entire temperature control circuit due to temperature changes. In this case, air present in the storage tank can be compressed by the expanding temperature control agent.

A disadvantage of such a temperature control circuit with a storage tank is that the temperature control agent present in the storage tank can be displaced when lateral acceleration or external forces acting on the storage tank cause an acceleration of the storage tank, the temperature control agent in the storage tank can “slosh back and forth” due to external forces acting on the storage tank when the motor vehicle or similar is driving around a curve or the like. However, this is accompanied by the risk that, due to the movement and foaming of the temperature control agent in the storage tank, the air present in the storage tank and serving as an equalizing volume can reach an outlet in the storage tank housing that is actually intended for the temperature control agent to escape through and can escape from the storage tank through this outlet. This can lead to a significant reduction in the efficiency of the temperature control. Furthermore, there is a risk of damage to individual components of the temperature control circuit due to air that has escaped from the storage tank and is consequently circulating together with the temperature control agent in the temperature control circuit. In particular, there is a risk of damage or even destruction of a conveyor system arranged in the temperature control circuit, typically in the form of a fluid pump or oil pump, due to the air present in the temperature control agent. There is also a risk of at least partial overheating of the battery.

### SUMMARY

It is therefore one purpose of the present invention to provide an improved embodiment for a temperature control arrangement, temperature control circuit, and storage tank for buffering the temperature control agent, in which the risk of undesired movement of the temperature control agent in the storage tank in the sense of the “sloshing back and forth” explained above is at least reduced.

This object is achieved by the scope of the independent claim(s). Preferred embodiments are the subject matter of the dependent claim(s).

The basic idea of the invention is therefore to arrange a molded body made of an open-pored foam material, through which the temperature control agent can flow, in the housing interior of the storage tank. A molded body of this type, as a foam, forms a large number of individual fluid channels through which the temperature control agent can flow in each case, to which the temperature control agent is distributed when flowing through the molded body. Such a distribution of the fluid will at least greatly counteract the “sloshing” of the temperature control agent under acceleration, as explained above.

This in turn prevents unwanted movement or flow of air in the storage tank due to the movement of the temperature control agent in the storage tank, which could result in air escaping from the storage tank. This can counteract damage to components that are arranged in a temperature control circuit through which the temperature control agent can flow, in the same way as the storage tank, as a result of air present in the temperature control circuit in addition to the temperature control agent. This applies in particular to an existing pump for pumping the temperature control agent in the temperature control circuit, which proves to be particularly sensitive to damage caused by air in the temperature control circuit. The operational reliability of the entire temperature control circuit can therefore be increased by means of the aforementioned molded foam body.

In detail, a temperature control arrangement according to the invention comprises a temperature control circuit in which a temperature control agent can be circulated and in which the component whose temperature is to be controlled is arranged, so that heat can be transferred between this component and the temperature control agent. The temperature control agent may be an oil in particular. In particular, a mineral oil, such as the one commercially available under the name “Mobil Elite 701”, can be used as a temperature control agent or oil for the temperature control circuit. Furthermore, the temperature control arrangement includes a conveyor system for driving the temperature control agent in the temperature control circuit. Furthermore, the temperature control arrangement includes a storage tank arranged in the temperature control circuit for the intermediate storage of the temperature control agent. The storage tank in turn comprises a housing that surrounds a housing interior through which the temperature control agent can flow, for holding the temperature control agent. Furthermore, the storage tank includes a fluid inlet, which is arranged on the housing and has an inlet opening, for introducing the temperature control agent into the housing interior, and a fluid outlet, which is arranged on the housing and has an outlet opening, for discharging the temperature control agent after it has flowed through the housing interior. According to the invention, at least one molded body, as previously explained, made of an open-pored foam material and through which the temperature control agent can flow, is arranged in the housing interior of the storage tank.

In particular, the foam may comprise polyurethane or consist of polyurethane. Such polyurethane is commercially available and therefore inexpensive to procure. Furthermore, it is easy to machine, so that the geometric shape of the molded body can easily be adapted to the geometry of the housing interior of the storage tank in which the molded body is to be placed.

In a preferred embodiment, a volume density of the molded body is at most 3%. This ensures that there is also sufficient volume available within the molded body for the temperature control agent to flow through. This counteracts an excessive drop in the fluid pressure of the temperature control agent due to the flow through the molded part.

According to a favorable further development of the temperature control arrangement according to the invention, the housing comprises at least one partition which subdivides the housing interior into a first partial space and at least one second partial space. Particularly preferably, the partition extends along a direction of gravity when the storage tank is arranged in a preferred position of use. The at least one partition and the resulting subdivision of the housing interior into at least two partial spaces not only subdivides the entire volume of the housing interior, but also counteracts the aforementioned unwanted movement of the temperature control agent present in the respective partial space in the sense of “sloshing” in addition to the essential shape of the invention. In this further training, a molded foam body is arranged in at least one of the partial spaces formed, preferably in each.

In another preferred embodiment, the molded body can extend over at least 50%, preferably at least 80%, most preferably at least 90%, of an interior volume of the housing interior or a partial space. The molded body may extend over the entire housing interior or its interior volume.

The component whose temperature is to be controlled can be particularly useful in an electric battery, in particular of a motor vehicle, or in a fuel cell system with at least one fuel cell. The fuel cell system can also be part of a motor vehicle or, alternatively, a stationary fuel cell system.

In a preferred embodiment, the component whose temperature is to be controlled is arranged in the temperature control circuit so that the temperature control agent can flow directly around it. This type of temperature control or cooling is known as “immersion cooling,” which can be used to achieve a particularly efficient transfer of heat between the temperature control agent and the component.

According to a favorable further development, the molded body is supported on at least one housing wall of the housing, preferably on two mutually opposite housing walls of the housing. Alternatively or additionally, in this further development, the molded body can be supported on at least one partition, preferably on two opposing housing walls of the storage tank. This ensures that the molded body is held firmly in the interior of the casing, even when external force is applied, in particular in the form of mechanical shocks or impacts.

According to a further advantageous training, the inlet opening is arranged in a first housing wall of the housing. In addition, in this further development, the outlet opening is arranged in a second housing wall, opposite the first housing wall. In this further training, the first housing wall in a preferred position of use of the storage tank with regard to the direction of gravity forms an upper side and the second housing wall forms a lower side of the housing. This ensures that the air, which is lighter than the temperature control agent and consequently located above the temperature control agent in the housing interior, does not enter the temperature control circuit via the outlet. With the help of the molded body essential to the invention, this is avoided even when external force is applied in the form of mechanical blows or impacts or when the storage tank is accelerated, as can occur when the storage tank or the temperature control arrangement with the storage tank is used in a motor vehicle.

A further embodiment of the storage ratio according to the invention has proven to be particularly advantageous, in which the first housing wall forms an upper side and the second housing wall forms a lower side of the housing in a preferred position of the storage tank with regard to the direction of gravity. This ensures that the air, which is lighter than the temperature control agent and is therefore located above the temperature control agent in the housing interior, does not enter the temperature control circuit via the outlet.

Further important features and advantages of the invention are apparent from the sub- claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown-schematically in each case-in the images below:

FIG. 1 is a schematic representation of an example of a temperature control arrangement according to the invention,

FIG. 2 is a cutaway view of the storage tank of the temperature control arrangement in FIG. 1,

FIG. 3 shows the molded foam body of the temperature control arrangement of FIG. 1 in a separate illustration.

### DETAILED DESCRIPTION

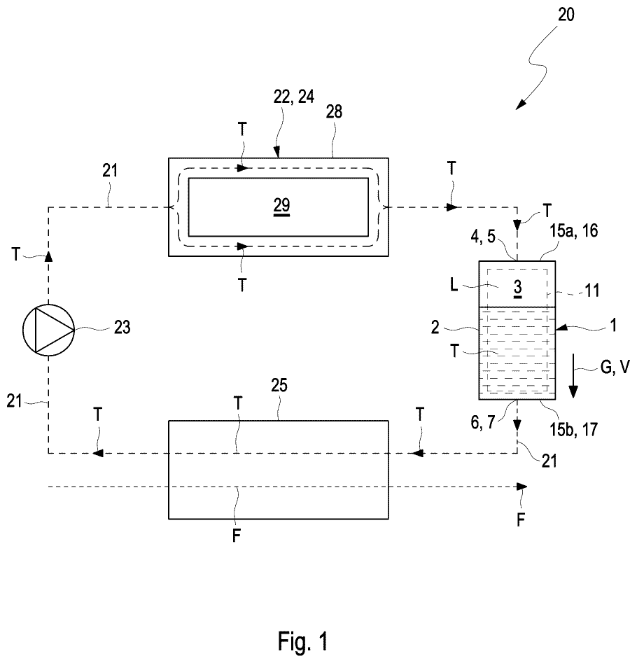

FIG. 1 shows an example of a temperature control arrangement 20 according to the invention in the form of a circuit diagram. The temperature control arrangement 20 comprises a temperature control circuit 21 in which a temperature control agent T circulates during operation of the temperature control arrangement 20 and in which a component 22 whose temperature is to be controlled is arranged so that heat can be transferred between this component 22 and the temperature control agent T. In this way, the temperature of the component 22 can be controlled, i.e., in particular, it can also be cooled. For example, the component 22 whose temperature is to be controlled can be an electric battery 24 of a battery-powered electric motor vehicle. The component 22 whose temperature is to be controlled can also be a fuel cell system with one or more fuel cells. In the example scenario, as indicated in FIG. 1, the component 22 whose temperature is to be controlled, i.e., the battery 24, is arranged in the temperature control circuit 21 so that the temperature control agent T can flow directly around it. For this purpose, the battery 24 can have a battery housing 28 through which the temperature control agent T can flow, in which several battery cells 29 whose temperature is to be controlled are arranged. Thus, the temperature control agent T flowing through the battery housing 28 can absorb heat from the battery cells 29 if they are to be cooled, or give off heat to the battery cells 29 if they are to be heated.

Furthermore, the temperature control arrangement 20 comprises a conveying device 23 for driving the temperature control agent T in the temperature control circuit 21. The conveyor system can be, for example, a fluid or oil pump.

Furthermore, a heat exchanger 25 through which the temperature control agent T can flow can be arranged in the temperature control circuit 21. In addition, a further fluid can first flow through the heat exchanger 25, separated from the temperature control agent T, which can be thermally connected to the temperature control agent T within the heat exchanger 25. In this way, heat can be transferred from the temperature control agent T to the fluid F to cool the temperature control agent T, or, conversely, heat can be transferred from the fluid F to the temperature control agent T if the heat transfer agent T is to be heated.

As can be seen from FIG. 1, the temperature control arrangement 20 also includes a storage tank 1 arranged in the temperature control circuit 21 for the intermediate storage of the temperature control agent T. The storage tank 1 can also function as an equalizing tank 1.

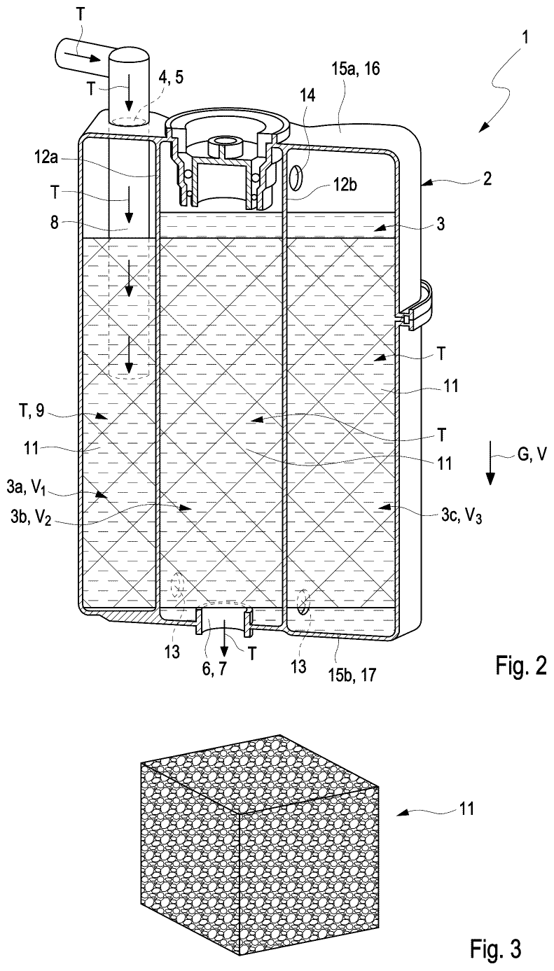

FIG. 2 shows the storage tank 1 separately and in a cutaway view. Accordingly, the storage tank 1 comprises a housing 2 which surrounds a housing interior 3 through which the temperature control agent T can flow for the intermediate storage of the temperature control agent T. Furthermore, the storage tank 1 comprises a fluid inlet 5, which is arranged on the housing 2 and has an inlet opening 4 for introducing the temperature control agent T into the housing interior 3 and a fluid outlet 7 arranged on the housing 2 and having an outlet opening 6 for discharging the temperature control agent T after flowing through the housing interior 3. The inlet opening 4 is arranged in a first housing wall 15a of the housing 2. The outlet port 6 is arranged in a second housing wall 15b of the housing 2, which is opposite the first housing wall 15a. FIG. 2 shows storage tank 1 in a preferred position of use for storage tank 1. In the position of use shown, the first housing wall 15a of the storage tank 1 forms an upper side 16 and the second housing wall 15b forms a lower side 17 of the housing 2 with respect to a direction G of gravity.

As can be seen in FIG. 2, the temperature control agent T is arranged in a lower area of the housing interior 3 due to gravity. In the operating position shown, air L can be arranged above the temperature control agent T as an equalizing volume in the housing interior 3 (see FIG. 1). This air L can be compressed by the temperature control agent T when the latter expands to a certain extent due to temperature. To ensure that the air L remains in the housing interior 3 of the storage tank 1 and cannot enter the temperature control circuit 21 via the outlet 6, the outlet 6 is arranged in the lower side 17 of the housing 2. Accordingly, as shown in FIG. 2, a pipe socket 8 can protrude from the inlet opening 4 or from the fluid inlet 5 into the housing interior 3, via which the temperature control agent T is introduced into a region 9 of the housing interior 3, which is arranged below the air L and is filled with the temperature control agent T.

As illustrated in FIGS. 1 and 2, at least one molded foam body 11 through which the temperature control agent T can flow is arranged in the housing interior 3 of the storage tank 1, as is shown in a separate illustration for the sake of clarity in FIG. 3. The foam of molded body 11 can be polyurethane, for example. In the example, the volume density of the molded body 11 is at most 3%.

In the example of FIG. 2, the housing 2 comprises two partitions 12a, 12b, which divide the housing interior 3 into a first, second, and third partial space 3a, 3b, 3c. The partitions 12a, 12b each extend from the upper side 16 to the lower side 17 and thus along a vertical direction V of the storage tank 1, which is parallel to the direction of gravity. The two partitions 12a, 12b and the associated subdivision of the housing interior 3 into three separate partial spaces 3a, 3b, 3c additionally counteract unwanted movements of the temperature control agent T in the housing interior 3 in the sense of “sloshing” against the molded body 11.

The two partitions 12a, 12b are advantageously integrally formed on the housing 2 as shown, which means that the two partitions 12a, 12b and the housing 2 are formed in one piece and from the same material. In order to ensure that all of the temperature control agent T present in the storage tank 1 is also available for flowing through the temperature control circuit 21, a respective opening 13 can be provided at a suitable point in the two partitions 12a, 12b, through which the first partial space 3a can communicate fluidically with the second partial space 3b and the second partial space 3b can communicate fluidically with the third partial space 3c. Likewise, an opening 14 can be provided in the second partition 12b, via which the air L present in the second partial space 3b can communicate fluidically with the air L present in the third partial space 3c.

In the example, a molded body 11 is arranged in all three partial spaces 3a, 3b, 3c. In variants of the example, one or two of the three partial spaces 3a, 3b, 3c can dispense with the foam body 11. In the example, each of the molded bodies 11 can extend over at least 50%, preferably over at least 80%, more preferably over at least 90%, of an interior volume V₁, V₂, V₃ of that partial space 3a, 3b, 3c in which it is arranged.

In a simplified variant of the storage tank 1, the provision of the partitions 12a, 12b and the associated subdivision of the housing interior 3 into a first, second, and third partial space 3a, 3b, 3c can be dispensed with.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A temperature control arrangement for controlling the temperature of at least one component, comprising:
a temperature control circuit through which a temperature control agent is circulatable and in which the at least one component is arranged such that heat is transferrable between the at least one component and the temperature control agent;
a conveyor configured to drive the temperature control agent in the temperature control circuit; and
a storage tank arranged in the temperature control circuit for intermediate storage of the temperature control agent, the storage tank including:
a housing surrounding a housing interior through which the temperature control agent is flowable, the housing interior configured to hold the temperature control agent;
a fluid inlet arranged on the housing, the fluid inlet having an inlet opening via which the temperature control agent is introducible into the housing interior;
a fluid outlet arranged on the housing, the fluid outlet having an outlet opening via which the temperature control agent is dischargeable after passing through the housing interior; and
at least one molded body composed of an open-pored foam and through which the temperature control agent is flowable, the at least one molded body arranged in the housing interior.

2. The temperature control arrangement according to claim 1, wherein the open-pored foam includes and/or is polyurethane.

3. The temperature control arrangement according to claim 1, wherein a volume density of the at least one molded body is 3% or less.

4. The temperature control arrangement according to claim 1, wherein:
the housing includes at least one partition subdividing the housing interior into a first partial space and at least one second partial space; and
the at least one molded body is arranged in the first partial space and/or in the at least one second partial space.

5. The temperature control according to claim 1, wherein the at least one molded body extends over at least 50% of an interior volume of the housing interior.

6. The temperature control arrangement according to claim 1, wherein the at least one component is:
an electric battery; and/or
a fuel cell system with at least one fuel cell.

7. The temperature control arrangement according to claim 1, wherein the at least one component is arranged in the temperature control circuit such that the temperature control agent flows directly around the at least one component.

8. The temperature control arrangement according to claim 1, wherein the at least one molded body is supported on at least one housing wall of the housing.

9. The temperature control arrangement according to claim 1, wherein:
the inlet opening is arranged in a first housing wall of the housing;
the outlet opening is arranged in a second housing wall of the housing, which is opposite the first housing wall; and
the first housing wall forms an upper side and the second housing wall forms a lower side of the housing in a position of use of the storage tank with respect to a direction of gravity.

10. The temperature control arrangement according to claim 1, wherein:
the inlet opening is arranged in a first housing wall of the housing; and
the outlet opening is arranged in a second housing wall of the housing, which is arranged opposite the first housing wall.

11. The temperature control arrangement according to claim 10, wherein, with respect to a direction of gravity, the first housing wall defines an upper side of the housing and the second housing wall defines a lower side of the housing.

12. The temperature control arrangement according to claim 1, wherein the storage tank is an equalizing tank.

13. The temperature control according to claim 5, wherein the at least one molded body extends over at least 90% of the interior volume of the housing interior.

14. The temperature control arrangement according to claim 4, wherein the at least one molded body is supported on the at least one partition.

15. The temperature control arrangement according to claim 1, wherein:
the housing includes at least one partition subdividing the housing interior into a plurality of partial spaces;
the at least one molded body includes a plurality of molded bodies; and
at least one of the plurality of molded bodies is arranged in each of the plurality of partial spaces.

16. The temperature control arrangement according to claim 1, wherein:
the housing includes a plurality of partitions subdividing the housing interior into a plurality of partial spaces, the plurality of partial spaces including a first partial space, a second partial space, and a third partial space; and
the plurality of partitions includes i) a first partition arranged between and separating the first partial space and the second partial space and ii) a second partition arranged between and separating the second partial space and the third partial space.

17. The temperature control arrangement according to claim 16, wherein the storage tank further includes a pipe socket protruding from the fluid inlet into the first partial space and through which the temperature control agent is flowable into an agent-filled region of the first partial space, which is disposed below an air-filled region of the first partial space.

18. The temperature control arrangement according to claim 16, wherein:
the first partition includes a first opening via which the temperature control agent is flowable between the first partial space and the second partial space; and
the second partition includes a second opening via which the temperature control agent is flowable between the second partial space and the third partial space.

19. The temperature control arrangement according to claim 18, wherein:
the inlet opening is arranged in a first housing wall of the housing;
the outlet opening is arranged in a second housing wall of the housing, which is arranged opposite the first housing wall;
the first opening is disposed in the first partition adjacent to the second housing wall;
the second opening is disposed in the second partition adjacent to the second housing wall; and
the second partition further includes a third opening via which air is flowable between the second partial space and the third partial space, the third opening disposed in the second partition adjacent to the first housing wall.

20. The temperature control arrangement according to claim 19, wherein:
the plurality of partitions each extend vertically from the first housing wall to the second housing wall; and
the first housing wall, the second housing wall, and the plurality of partitions are integrally connected such that the housing is a monolithic component.
